(19) United States
(12) Patent Application Publication
(10) Pub. No.: US 2005/0097241 A1
(43) Pub. Date: May 5, 2005

(54) Portable storage device

(75) Inventor: Chang-Hung Lee, YunLin (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 10/979,150

(22) Filed: Nov. 3, 2004

(30) Foreign Application Priority Data
Nov. 4, 2003 (TW) 92130755

(51) Int. Cl. G06F 13/00

(52) U.S. Cl. 710/32

(57) ABSTRACT

The present invention relates to a portable storage device, which is capable of switching between a first operating mode and a second operating mode. The storage device comprises: a connection unit, a processing unit, a memory, and a display. The connection unit is capable of detecting an electric signal. The memory is used for storing data. The processing unit switches between the first and the second operating modes according to the electric signal detected, and accesses data accordingly. The display is capable of displaying the statuses of the storage device.

### 1. FIELD OF THE INVENTION

The present invention relates to a portable storage device, and more particularly, to a portable storage device that is capable of determining the desired operating mode automatically by sensing a current of interface.

### 2. DESCRIPTION OF THE PRIOR ART

With the extensive uses of USB in data transferring, the advantages of using USB, such as the fast transfer rate, the hot-swap capability enabling the convenience of not requiring a user to reboot the computer, etc., have advanced the application of computer peripherals into a new era. As in the conventional CD-ROMs, CD recorders, digital voice recorders, computers, and digital cameras, they are all equipped with the USB interfaces as data transfer interface. Hence, nowadays the applications of USB really play a very important role in our lives.

Typically, the memory of the conventional digital camera is less than 256 MB. While a user can always download image files stored in the digital camera to a computer whenever the memory of the digital camera is full, a capacity of 256 MB is usually not sufficient. Currently, there is a kind of external micro-disc that provides a greater storage capacity (approximately 20 GB) and is capable of downloading the image files from a digital camera and uploading them to a computer. When operating the micro-disc, however, the user is required to determine the operating mode and, with a switch equipped on the memory device, has to switch the device to a desired operating mode manually.

The method described above is very inconvenient in usage, that is, the operating mode needs to be determined by the user. The object of the present invention is to provide a portable storage device that, by sensing an electric signal, is capable of determining and switching the device to a desired operating mode automatically.

### SUMMARY OF THE INVENTION

The primary object of the present invention is to provide a portable storage device that, by sensing an electric signal, is capable of switching between the host mode and the device mode automatically for downloading or uploading files.

To achieve the object described above, the present invention of a portable storage device comprises: a connection unit, a processing unit, a memory, an power storage unit, and a display. The connection unit is used to detect an electric signal and the power storage unit is for providing power to the portable storage device. The processing unit is coupled to the connection unit and is set to a first mode by default, which can be selectively switched to a second mode according to the level of the detected electric signal. The memory is coupled to the processing unit for storing data. The display is adapted for displaying information stored in the memory. The processing unit determines and switches among operating modes according to the level of the electric signal detected.

To further describe the objects and features of the present invention, drawings and detailed description of the preferred embodiment are presented.

### BRIEF DESCRIPTION OF THE DRAWINGS

FIG. 1 is a drawing of a portable storage device depicting a preferred embodiment of the present invention.

FIG. 2 is a schematic drawing of a portable storage device of the present invention functioning with a digital camera.

FIG. 3 is a schematic drawing of a portable storage device of the present invention functioning with a notebook computer.

### DETAILED DESCRIPTION OF THE PREFERRED EMBODIMENT

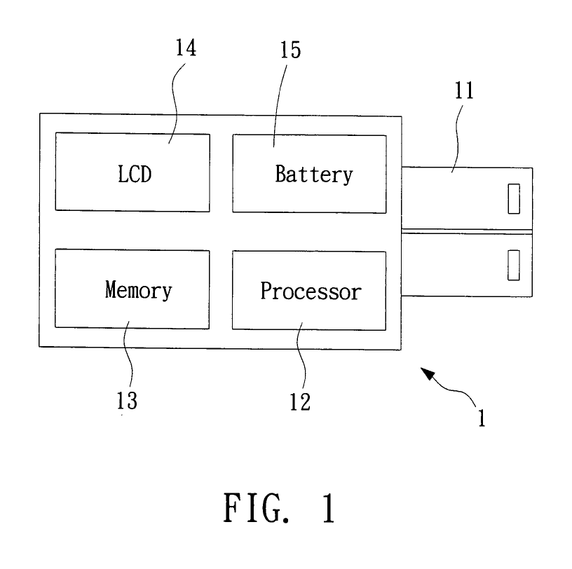

Please refer to FIG. 1, which is a drawing of a portable storage device depicting a preferred embodiment of the present invention. The portable storage device comprises: a Universal Serial Bus Interface (USB) 11, a processing unit 12, a memory 13, a battery 15, and a liquid crystal display (LCD) 14.

In the present preferred embodiment, the Universal Serial Bus interface 11 detects an electric signal when an external device is connected, wherein the electric signal is a current value defined in the Universal Serial Bus standard (i.e. USB 1.1 or USB 2.0). The processing unit 12 is coupled to the Universal Serial Bus (USB) interface 11 and is set to a host mode as default. While operating in the host mode, the data in the external device connected to the portable storage device 1 can be transferred to the memory 13 automatically. Besides, according to the electric signal detected, the processing unit 12 can selectively switch the portable storage device into a device mode. While operating in the device mode, the data in the memory 13 can be transferred to the external device automatically. In the host mode, the battery 15 provides the electric power for the processing unit 12, the memory 13, and the LCD display 14. The LCD 14 is capable of displaying the information stored in the memory 13, such as portraits, scenery, etc., and is also capable of displaying the operating mode of the portable storage device 1.

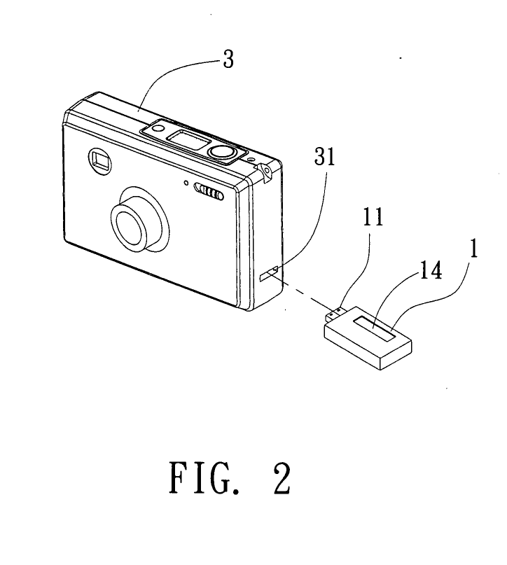

Please refer to FIG. 2, which is a schematic drawing of a portable storage device connecting with a digital camera depicting a preferred embodiment of the present invention. The digital camera 3 has an USB interface 31. The USB interface 31 can input or output image files through the digital camera 3. When the USB interface of a portable storage device, such as a digital camera or a cellular phone, connecting to the USB interface of a peripheral device. The portable storage device is provided power by batteries. The peripheral device will not provide extra power outwardly to the portable storage device. In other way, while a peripheral device is connected to a computer, the computer as a host device such that the peripheral device will drain electric current from the host device. Moreover, the host device can control the direction of data flow, where the peripheral device in the device mode passively controlled by the host device. Therefore, as the portable storage device 1 is connected to the USB interface 31 of the digital camera, a first current of a current value, approximately 0.5 A, will be generated and is provided by the battery 15. By detecting the current value, the processing unit 12 can identify that the portable storage device is connected with the digital camera 3 and it will automatically switch to the host mode. In the host mode, the image files of the digital camera 3 can be automatically transferred and stored in the memory 13 of the portable storage device 1. In addition, the image files and the current operation mode, i.e. host mode, of the portable storage device can be displayed on the LCD display 14.

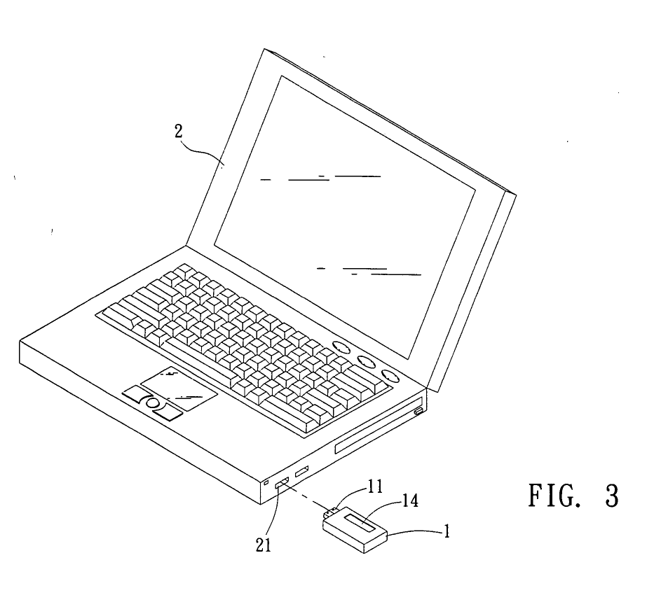

Please refer to FIG. 3, which is a schematic drawing of a portable storage device connecting to a notebook computer depicting a preferred embodiment of the present invention. The notebook computer 2 has at least one USB interface 21 which can be used to transfer data. As the USB interface 11 of the portable storage device is connected to the USB interface 21 of the computer. The USB interface 21 of the notebook computer will generate a second current. Whether the notebook computer is running on batteries or is plugged in extra power line. The notebook computer typically has more power than the peripherals so that it always operates in the host mode and will not drain any power from the peripherals connected to it. Although there is the second current generated, the second current tends to close to 0 A. By sensing this second current, the processing unit 12 can identify that the portable storage device 1 is connected with a host device and will switch the portable storage device 1 to the device mode automatically. Meanwhile, the external portable storage device 1 is able to drain power from the notebook computer 2 and the battery 15 will stop providing power. In the device mode, the portable storage device 1 may automatically transfer the image files stored in the memory 13 to the notebook computer 2, or it can be used as an external hard disc for the notebook computer 2 to read or write data. While finish using, the processing unit 12 will switch the storage device back to the host mode after disconnecting the USB interface of the notebook computer. On the other hand, by referencing the detected current value of the USB interface 21 to a reference value resided inside the processing unit 12, the processing unit 12 can also decide and switch the operating mode of the storage device 1 in either the device or the host mode.

According to the above description, the portable storage device 1 is surely capable of switching the operating mode automatically instead of requiring a user to switch it manually, which indeed overcomes the disadvantages of the prior art, and satisfies the demand and increases the competitiveness for the industry.

The above-mentioned embodiment is only the preferable embodiment. The scope of the present invention certainly is not limited by the embodiments shown. Therefore, any small variation and modification based on the appended claims that possesses the merit of the present invention should be considered within the scope and the spirit of the present invention.

1. A portable storage device for selectively switching between a first operating mode and a second operating mode and connecting to an external device, comprising:
a connection unit for detecting an electric signal between said external device and said portable storage device;
a memory for storing data; and
a processing unit coupling to said connection unit and said memory, selectively switching between said first and said second operating modes according to said electric signal, and accessing data accordingly.

2. The storage device of claim 1, wherein said storage device further comprises: a display, coupled to said processing unit for displaying statuses of said storage device.

3. The storage device of claim 1, wherein said connection unit has a universal serial bus interface.

4. The storage device of claim 1, wherein said electric signal is an electric current.

5. The storage device of claim 1, wherein said first operating mode is a host mode, and said processing unit reads data from said external device and stores them in said memory through said connection unit.

6. The storage device of claim 1, wherein said second operating mode is a device mode, and said processing unit writes data stored in said memory to said external device through said connection unit.

7. The storage device of claim 4, wherein said first operating mode is a host mode and said second operating mode is a device mode.

8. The storage device of claim 7, wherein said portable storage device is in said host mode as the value of said electric current is larger than a reference value.

9. The storage device of claim 7, wherein said portable storage device is in said device mode as the value of said electric current is smaller than a reference value.

10. The storage device of claim 1, wherein said second operating mode is a device mode, and when said external device is in a host mode, said external device is automatically accessing to said portable storage device.

11. The storage device of claim 1, wherein said storage device further comprises: a battery, adapted for providing electric power while said storage device is operating in said first operating mode.

12. A portable storage device for connecting to an external device, comprising:
a connection unit for connecting said portable storage device and said external device and detecting an electric signal between said external device and said storage device;
a memory;
a processing unit, coupled to said connection unit and said memory, for selectively switching between said first and said second operating modes according to said electric signal, and accessing data from said memory accordingly.

13. The storage device of claim 12, wherein said first operating mode is a host mode and said second operating mode is a device mode.

14. The storage device of claim 13, wherein said storage device is in said host mode as said electric signal is greater than a reference value.

15. The storage device of claim 13, wherein said storage device is in said device mode as said electric signal is lower than a reference value.

16. The storage device of claim 13, wherein said storage device is in said host mode when said storage device is detached from said external device.
